(19) United States
(12) Patent Application Publication
(10) Pub. No.: US 2019/0201979 A1
(43) Pub. Date: Jul. 4, 2019

(54) SYSTEMS AND METHODS FOR Z-HEIGHT MEASUREMENT AND ADJUSTMENT IN ADDITIVE MANUFACTURING

(71) Applicant: ARCONIC INC., Pittsburgh, PA (US)

(72) Inventors: Wei Huang, Mars, PA (US); Michael Globig, New Kensington, PA (US)

(21) Appl. No.: 16/298,594

(22) Filed: Mar. 11, 2019

Related U.S. Application Data
(63) Continuation of application No. PCT/US2017/051829, filed on Sep. 15, 2017.
Application No. PCT/US2017/051829 is a continuation of application No. 62/395,032, filed on Sep. 15, 2016.

(51) Int. Cl. B22F 3/105

(52) U.S. Cl. CPC B22F 3/1055; B33Y 10/00

(57) ABSTRACT

In some embodiments of the instant disclosure, a method is provided comprising: additively manufacturing a part via a material deposition-based additive manufacturing technique; concomitant with additively manufacturing the part, measuring a z-height of the deposition via a non-linear mathematical model to determine a measured z-height, wherein the measured z-height is a distance between an additive manufacturing system energy source and a top surface of a molten pool; comparing the measured z-height with a target z-height to identify a difference between the measured z-height and the target z-height; adjusting a motion controller to set a corrected z-height; and depositing an additive manufacturing feed material based on the corrected z-height.

### CROSS-REFERENCE TO RELATED APPLICATIONS

This application is a continuation of International Patent Application No. PCT/US2017/051829, filed Sep. 15, 2017, which claims the benefit of U.S. provisional application No. 62/395,032 filed on Sep. 15, 2016, each of which is herein incorporated by reference in its entirety.

### FIELD

Broadly, the instant disclosure is directed towards various embodiments of an apparatus and method for z-height measurement and control for an additive manufacturing (AM) material deposition process.

More specifically, the present disclosure relates to systems and methods for generating a non-linear mathematical model to measure z-height of an AM deposition and provide an automated adjustment parameter if the measured z-height differs from the target z-height.

### BACKGROUND

Precise and accurate deposition of additive manufacturing (AM) feed material is required to achieve an AM part build with accurate geometry and consistent properties (e.g. microstructure).

### SUMMARY

In some embodiments of the instant disclosure, a method is provided comprising: additively manufacturing a part via a material deposition-based additive manufacturing technique; concomitant with additively manufacturing the part, measuring a z-height of the deposition via a non-linear mathematical model to determine a measured z-height, wherein the measured z-height is a distance between an additive manufacturing system energy source and a top surface of a molten pool; comparing the measured z-height with a target z-height to identify a difference between the measured z-height and the target z-height; adjusting a motion controller to set a corrected z-height, as the target z-height and the measured z-height; and depositing an additive manufacturing feed material based on the corrected z-height.

In any of the foregoing embodiments, additionally and/or alternatively adjusting a motion controller further comprises sending a signal to the motion controller coupled to the additive manufacturing system energy source to set the corrected z-height

In any of the foregoing embodiments, additionally and/or alternatively the non-linear mathematical calculations are:

$${Z}^{+} = SD + \frac{h sin β ( {L}_{1} - f )}{f sin α - h cos α sin β}$$

$${Z}^{-} = SD - \frac{h sin β ( {L}_{1} - f )}{f sin α + h cos α sin β}$$

wherein SD is the stand-off distance between the additive manufacturing system energy source and the molten pool or a surface of a deposited material in a previous layer, wherein h is a distance between an image point a and an image point b on a physical image sensor unit, wherein L1 is a distance from a lens center to the molten pool or to the surface of the deposited material in the previous layer, wherein α is an angle between a line Aa and a direction of energy, wherein β is an angle between the line Aa and an image sensor surface, and wherein f is a focal length.

In any of the foregoing embodiments, additionally and/or alternatively the z-height is a negative value.

In any of the foregoing embodiments, additionally and/or alternatively the additive manufacturing system energy source is adjusted downward in a vertical direction toward the molten pool.

In any of the foregoing embodiments, additionally and/or alternatively the z-height is a positive value.

In any of the foregoing embodiments, additionally and/or alternatively the additive manufacturing system energy source is adjusted upward in a vertical direction away from the molten pool.

In any of the foregoing embodiments, additionally and/or alternatively the material deposition-based additive manufacturing technique is a wire-fed deposition.

In any of the foregoing embodiments, additionally and/or alternatively the material deposition-based additive manufacturing technique is an injectable fluidized powder-based deposition.

In any of the foregoing embodiments, additionally and/or alternatively the measured z-height is the target z-height.

In any of the foregoing embodiments, additionally and/or alternatively the measuring the z-height comprises: taking an image of the molten pool via an imaging device; correlating and calculating the position of the molten pool relative to the additive manufacturing system energy source via a coordinate system; comparing the measured z height to the target z height; calculating a deviation between the measured z-height and the target z-height; and adjusting via the z-height controller, the height of the energy source relative to the top surface of the molten pool to minimize the deviation, if any, between the measured Z-height and the target z-height.

In any of the foregoing embodiments, additionally and/or alternatively the imaging device is configured to measure a distance between a lowermost portion of the energy source to the top surface of the molten pool.

In any of the foregoing embodiments, additionally and/or alternatively the parameters of the material deposition-based additive manufacturing technique are controlled in order to adjust the z-height.

In any of the foregoing embodiments, additionally and/or alternatively the z-height is adjusted based at least in part on adjusting a value of an E-beam power parameter.

In any of the foregoing embodiments, additionally and/or alternatively the z-height is adjusted based at least in part on adjusting a feed rate of the additive manufacturing feed material.

In any of the foregoing embodiments, additionally and/or alternatively the sensor enables automatic monitoring and/or control of the z-height.

In any of the foregoing embodiments, additionally and/or alternatively the measured z-height is compared with the target z-height concomitant with additively manufacturing the part.

In any of the foregoing embodiments, additionally and/or alternatively the motion controller is adjusted to provide a corrected z-height to reduce the difference between the target z-height and the corrected z-height, concomitant with additively manufacturing the part.

In some embodiments of the instant disclosure, a method is provided comprising: a substrate having a first surface configured to hold an additively manufactured part; an energy source disposed opposite the substrate and configured to direct an energy beam toward the first surface of the substrate; a fixture having a first end coupled to a housing of the energy source; a sensor coupled to a second end of the fixture, wherein the sensor is configured to image light in particular wavelengths emitted by hot additive manufacturing material; and a motion controller coupled to the energy source and configured to adjust a vertical distance from the energy source to a top surface of additively manufactured part.

In any of the foregoing embodiments, additionally and/or alternatively the motion controller comprises a motion motor and a controller.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 depicts a schematic view of an embodiment of the hardware system in accordance with some embodiments of the present disclosure.

FIG. 2A-C depicts three different examples of various z-heights and the resulting implications to the additive manufacturing (AM) part build in accordance with some embodiments of the present disclosure.

FIG. 3A and 3B depict two illustrative schematics of two different feed-based AM techniques that can employ one or more embodiments of the instant disclosure.

FIG. 4 depicts a schematic of an embodiment of the software system measurement and control loop, in accordance with some embodiments of the present disclosure.

FIG. 5 depicts an example of a non-linear mathematical model employable with the variables and component designs depicted in FIG. 1 in order to generate a z-height measurement (e.g. measured z-height) at a particular AM build layer, in accordance with some embodiments of the present disclosure.

FIG. 6 depicts an embodiment of the z-height sensor, in accordance with some embodiments of the present disclosure.

FIGS. 7A-7C depicts schematics and photographs of an embodiment of a z-height measurement device configuration utilized to evaluate the systems, in accordance with some embodiments of the present disclosure.

FIG. 8A and 8B are the experimental results of the configuration provided in FIG. 7A-7C, showing the z-height data obtained through an experimental assessment of an embodiment of a z-height system and z-height method in accordance with some embodiments of the present disclosure.

FIG. 9 depicts experimental data for the continuous z-height measurement results of the two different passes (AM bead deposition) for the embodiment of the in situ sensor that was tested in accordance with some embodiments of the present disclosure.

FIG. 10A and 10B depict examples of different z-height images and processing results obtained as part of the testing of an embodiment of the in situ sensor that was tested in accordance with some embodiments of the present disclosure.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

The present invention will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the present disclosure.

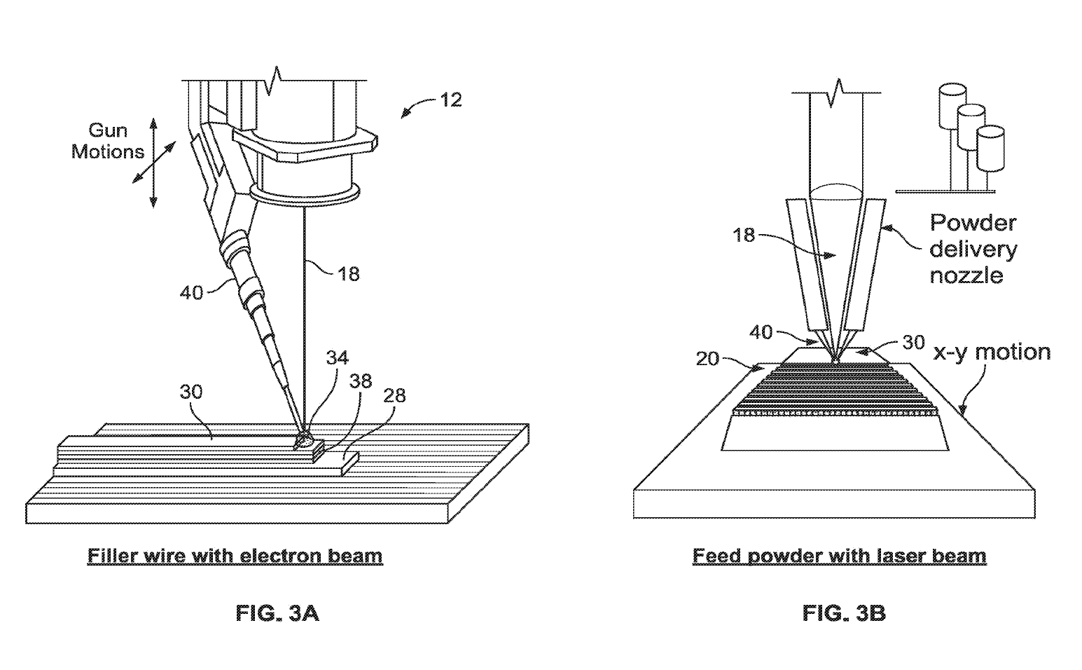

In some embodiments, in order to achieve mass production of complex additive manufacturing (AM) parts with accurate geometry and consistent quality, reliable process monitoring and control is critical. AM is a layer-by-layer building process with time-of-build as the key variable in achieving a viable business case. The material deposition based AM processes, such as the Sciaky®-type Electron Beam Additive Manufacturing and Optomec®-type systems, build parts by melting the deposited filler material or feed powder using a high energy source such as an electron-beam or a laser. FIGS. 3A and 3B depict two different exemplary types of additive manufacturing machines that could employ the systems and methods of the instant disclosure. FIG. 3A depicts an exemplary embodiment of a wire based AM deposition technique (i.e. filler wire with electron beam), as it is available through a Sciaky®-type AM machine, while FIG. 3B depicts an exemplary embodiment of an injectable, fluidized powder-based AM machine (i.e. feed powder with laser beam), as is available through an Optomec®-type AM machine.

Z-height is the distance between the top surface of the part being built (i.e. the top surface of the molten pool) and the AM system energy source. Momentive forces and/or distortions in the molten metal pool due to fluid mechanics makes it difficult to consistently achieve the target z-height during an AM part build without modifying the AM equipment during the AM part build to vary the z-height. Controlling the z-height is an important factor in achieving product quality.

Accordingly, in some embodiments of the instant disclosure, a method is provided for controlling the z-height. In some embodiments, the method comprises additively manufacturing a part via a material deposition-based additive manufacturing technique; concomitant with additively manufacturing the part, measuring a z-height of the deposition via a non-linear mathematical model to determine a measured z-height, wherein the measured z-height is a distance between an additive manufacturing system energy source and a top surface of a molten pool; comparing the measured z-height with a target z-height to identify a difference between the measured z-height and the target z-height; adjusting a motion controller to set a corrected z-height, as the target z-height and the measured z-height; and depositing an additive manufacturing feed material based on the corrected z-height.

In some embodiments, measuring a z-height of the deposition via a non-linear mathematical calculation further comprises: calculating the Z according to following equation:

$${Z}^{+} = SD + \frac{h sin β ( {L}_{1} - f )}{f sin α - h cos α sin β}$$

$${Z}^{-} = SD - \frac{h sin β ( {L}_{1} - f )}{f sin α + h cos α sin β}$$

where SD is the stand-off distance between the energy source and the molten pool or the surface of the deposited material in the previous layer (object point A), where h is the distance between the image point a (the image of object point A) and b (the image of object point B) on the physical image sensor unit, where L1 is the distance from the lens center to the object point A, where α is the angle between the line Aa and the direction of energy, where β is the angle between the line Aa and the image sensor surface, and where f is the focal length, such that where the z-height a negative value “Z−”, the object is above A (adjust/control such that motor moves e-beam down) and where the z-height is a positive value “Z+”, the object is below A (adjust/control such that motor moves e-beam down).

In some embodiments, comparing to a target z height comprises: evaluating whether the calculated Z is Z− or Z+.

In some embodiments, measuring the z-height comprises: taking an image of the molten pool via an imaging device; correlating and calculating the position of the molten pool relative to the additive manufacturing system energy source via a coordinate system; comparing the measured z height to the target z height; calculating a deviation between the measured z-height and the target z-height; and adjusting via the z-height controller, the height of the energy source relative to the top surface of the molten pool to minimize the deviation, if any, between the measured Z-height and the target z-height.

Various embodiments of the instant disclosure include systems and methods of z-height measurement and control (e.g. adjustment) for the additive manufacturing deposition process. These embodiments include a hardware systems (e.g. components including sensor, fixture, AM machine, to name a few) and software system/related processes (e.g. including the measurement module and feedback control module).

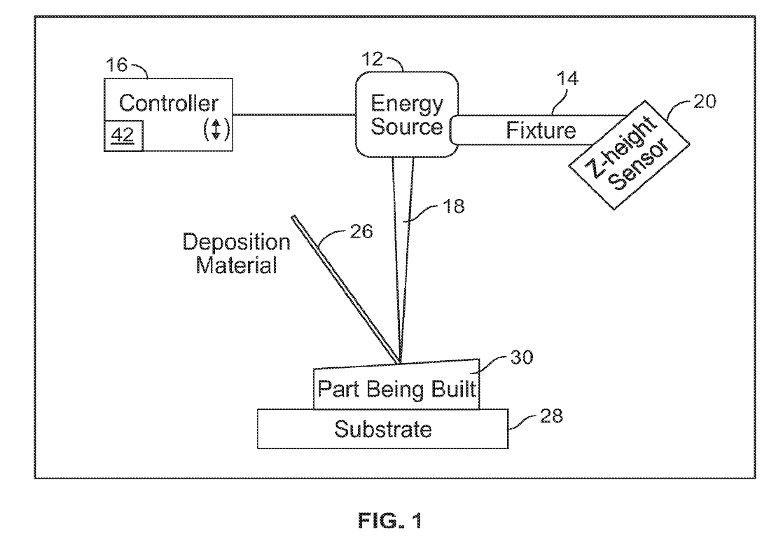

FIG. 1 depicts a schematic view of an exemplary embodiment of the hardware system in accordance with some embodiments of the present disclosure. FIG. 1 illustrates an embodiment of the hardware system where a z-height sensor is mounted (fixed) to an AM energy source via a fixture. FIG. 1 shows an embodiment of the relative positioning of an AM energy source, a z-height sensor, a deposition material (e.g. where feedstock is fed into the AM machine) and an AM build (e.g. part being built, on top of the substrate/platform). In some embodiments, the hardware system includes a z-height measurement sensor 20 (e.g. an imaging device and/or camera) and an arm (e.g. fixture 14) that is configured to attach the sensor 20 to the housing of the energy source 12 in a predetermined, fixed position relative to the housing of the energy source 12 of the AM machine. In some embodiments, the hardware system is disposed opposite (e.g. above) the AM part 30 being built on the substrate 28 (e.g. platform). In some embodiments, the hardware system further comprises a motion controller coupled to the energy source 12 (e.g. to the housing of the energy source) to adjust a vertical distance between the energy source and a top surface of the AM part 30. In some embodiments, the motion controller comprises a motion motor 42 and a controller 16.

In some embodiments, the sensor 20 is configured with: an imaging device (e.g. digital CCD Gigabit Ethernet camera), an optical lens-system, and a fixture configured to retain the camera and lens system. As described herein, the imaging device (camera) and the lens system is configured based on a non-linear mathematical model such that the geometrical positions, angles, and orientations of the imaging device and optical lens components are accurately arranged and/or aligned inside the fixture.

The sensor 20 is configured to image light in particular wavelengths emitted by the hot material (i.e. the AM deposition on the AM build), such that the equipment generating the energy source configured to deposit the feed material 26 onto the AM part 30 is also factored into the height measurement system. Thus, one or more embodiments of the instant disclosure utilize the melt pool, and not additional light sources, in order to utilize dimensional measurement by triangulation. More specifically, one or more of the embodiments of the instant disclosure utilize the principle of geometric triangulation in order to measure the required z-height of the deposited material relative to the energy source 20.

The software system includes a measurement module and a feedback control module. In some embodiments, the measurement module includes functions such as image acquisition, image processing and analysis, and Z-height calculation. The feedback control module is configured to utilize the measured Z-height (e.g. determined via a non-linear mathematical model) in closed-loop feedback control of the Z-axis positioning motor (e.g. motion motor) to achieve the desired intersection point between the energy source (e.g. electron beam or laser beam), deposited material (e.g. wire feed material or powder feed material), and part surface (e.g. surface of the AM part build).

In some embodiments, the hot molten pool is the result of either an electron beam energy source or laser energy source. In either case, the visible light emitted by the hot molten pool is imaged and used to calculate the z-height by the principle of triangulation. In one or more embodiments of the instant disclosure, the triangulation dimensional measurement utilizes the inherent energy source from the AM machine as part of the measurement scheme. In some embodiments, in lieu of utilizing the inherent energy source in the triangulation dimensional measurement, the camera/sensor is configured to image the infrared light emitted by the hot molten pool for the purposes of the triangulation measurement scheme. In one or more embodiments of the instant disclosure, the image processing methods are configured to overcome the irregular distribution of the inherent light source and/or molten pool (i.e. inherently irregular as a function of concurrent AM build).

In one or more embodiments of the instant disclosure, accurate z-height measurement and control results in improved material height control (e.g. automated monitoring, automated adjustment, and/or automated control of AM) during the AM deposition process.

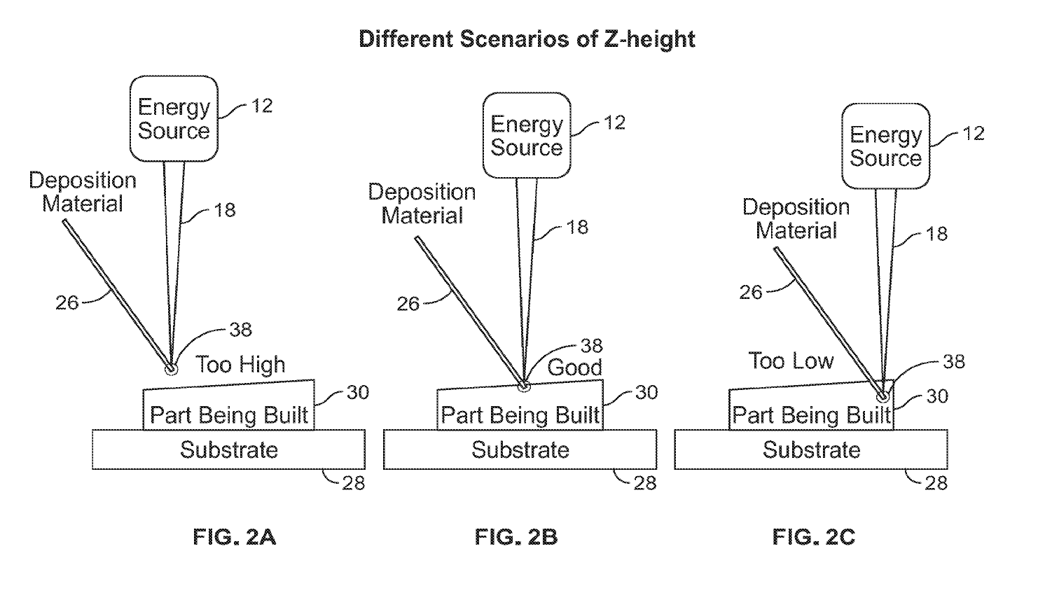

FIG. 2 depicts instances that are monitored and controlled with one or more of the embodiments of the instant disclosure. For example, FIG. 2A shows a measured z-height that is too high, where the deposition material and energy beam intersect above the AM part build (e.g. such that the AM deposit drips onto the surface of the AM part build). In this embodiment, the measured z-height obtained from the present embodiments would differ from the target z-height. Accordingly, the systems and methods described herein would incorporate a change in z-height actuated by the motor. For example, the systems and methods described herein would lower the energy source 12 to achieve a target z-height. Referring to FIG. 2B, the measured z-height is within a predetermined/acceptable range of the target z-height, such that the systems and methods monitor the z-height and confirm that no adjustment is required (e.g. no change in z-height). Referring to FIG. 2C, the measured z-height is too low, such that the e-beam and deposition material is dragging in the molten metal pool and may result in poor build quality or unstable process. In this embodiment, the measured z-height obtained from the present embodiments would differ from the target z-height, so that the systems and methods would incorporate a change in z-height actuated by the motor. For example, the systems and methods described herein would raise the energy source 12 to achieve a target z-height.

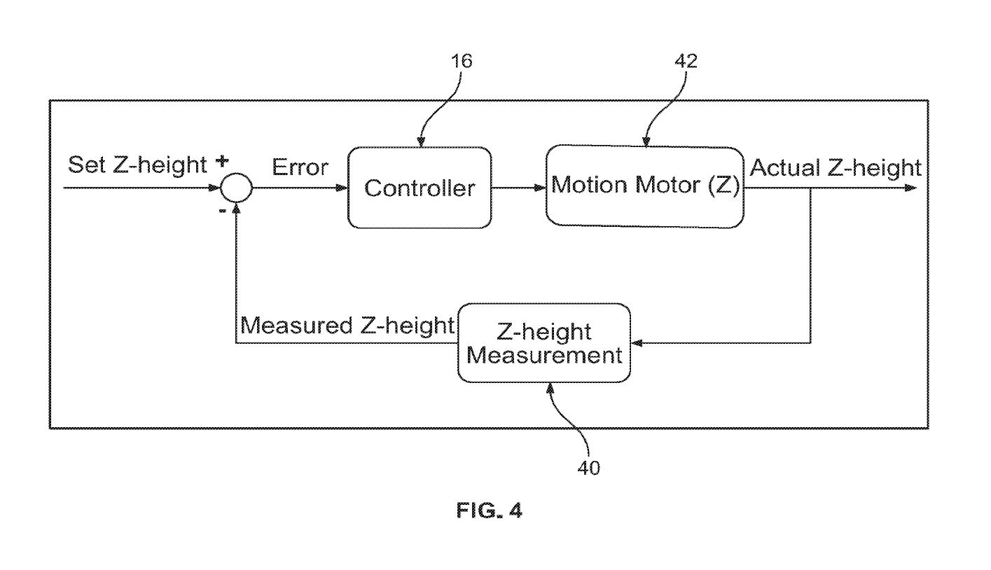

FIG. 4 depicts an exemplary embodiment of a feedback control module in accordance with some embodiments of the instant disclosure. FIG. 4 illustrates the z-height measurement, and also provides that the software system includes a z-height measurement module 44 and a feedback control module 16. The measurement module 44 (i.e. z-height measurement) includes functions such as image acquisition, image processing and analysis, and z-height calculation. The z-height calculation module was developed from a non-linear mathematic model, which incorporates a number of geometrical and optical lens parameters to provide for measurement within a predefined range, accuracy, and resolution.

As shown in FIG. 4, the feedback control module 16 is configured to use the z-height measured in real-time as close-loop feedback to control the z-axis position (i.e. if adjustment is needed) to achieve an actual/measured height that is consistent with (or within a predetermined threshold of) the target z-height of the energy source or the intersection point between the energy beam and the deposited material. That is, the actual z-height (measured z-height) is compared to the set z-height (target z-height) and if the two values are either (1) not the same or (2) differ by an amount that is outside of a predetermined threshold or range, then the energy source (e.g. E-beam gun or laser head) is moved/adjusted up or down, relative to the AM part build, by the motion motor to close the gap/difference between the measured z-height and the target z-height.

In some exemplary embodiments, the target z-height is set at 11 inches. In some exemplary embodiments, the target z-height is set at 10.5 inches. In some exemplary embodiments, the target z-height is set at 10 inches. In some exemplary embodiments, the target z-height is set at 11.5 inches. In some exemplary embodiments, the target z-height is set at 12 inches.

In some exemplary embodiments, the predetermined threshold or range is within 0.125 inches of the target z-height. In some exemplary embodiments, the predetermined threshold or range is within 0.120 inches of the target z-height. In some exemplary embodiments, the predetermined threshold or range is within 0.115 inches of the target z-height. In some exemplary embodiments, the predetermined threshold or range is within 0.110 inches of the target z-height.

In some exemplary embodiments, the predetermined threshold or range is within 0.130 inches of the target z-height. In some exemplary embodiments, the predetermined threshold or range is within 0.135 inches of the target z-height. In some exemplary embodiments, the predetermined threshold or range is within 0.140 inches of the target z-height. In some exemplary embodiments, the predetermined threshold or range is within 0.145 inches of the target z-height.

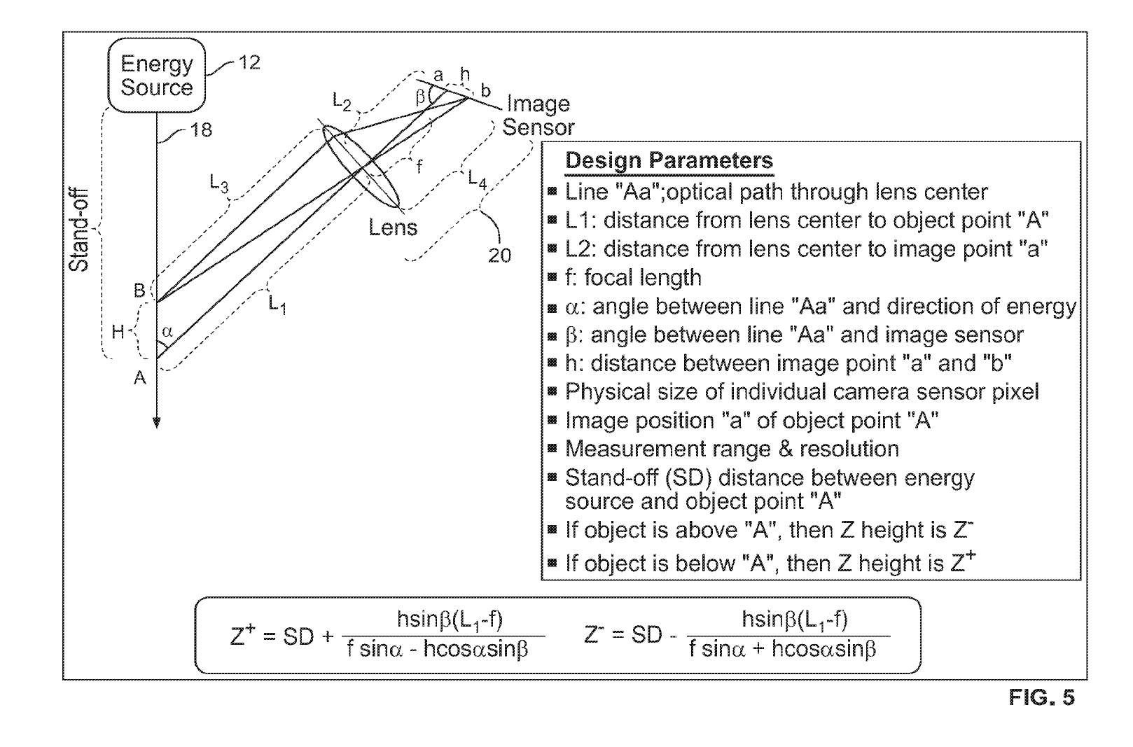

Referring to FIG. 5, the non-linear equations are provided, in conjunction with the design parameters utilized with one or more embodiments of the systems (e.g. sensors employed with the AM machines, in accordance with the instant disclosure. The non-linear equations are:

$${Z}^{+} = SD + \frac{h sin β ( {L}_{1} - f )}{f sin α - h cos α sin β}$$

$${Z}^{-} = SD - \frac{h sin β ( {L}_{1} - f )}{f sin α + h cos α sin β}$$

where SD is the stand-off distance between the energy source and the molten pool or the surface of the deposited material in the previous layer (object point A), h is the distance between the image point a (the image of object point A) and b (the image of object point B) on the physical image sensor unit, L1 is the distance from the lens center to the object point A, α is the angle between the line Aa and the direction of energy, β is the angle between the line Aa and the image sensor surface, and f is the focal length, such that where the z-height is Z−, the object is above A and where the z-height is Z+, the object is below A.

As a non-limiting example, as the z-height between the energy source and the molten pool on the part surface changes, the position of the molten pool in the image also changes. Based on the image position of the molten pool, the parameter h can be obtained and then the z-height can be calculated based on the above non-linear mathematical equations.

### Example: Embodiment of z-Height Sensor

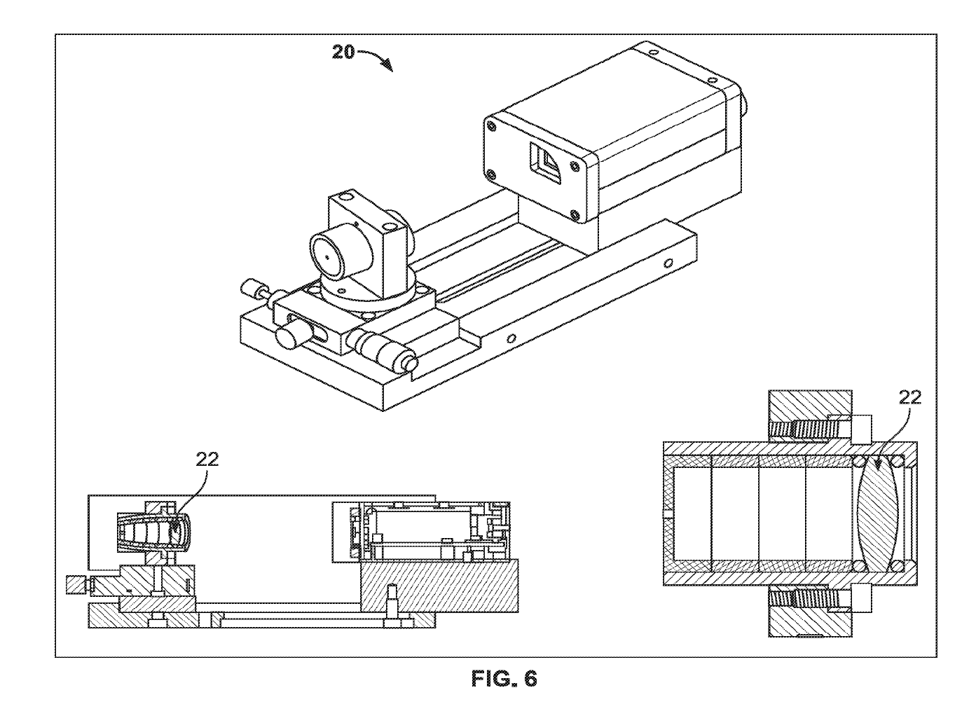

Referring to FIG. 6, a mounting fixture holds the camera and the optical lens components. The geometrical positions, angles and orientations of the camera and the optical lens components are adjustable and accurately positioned according to the developed non-linear mathematical model for z-height measurement. In this embodiment, the camera is a digital CCD camera with the C-mount lens adapter removed so that the optical lens components can be positioned in front of the CCD sensor unit at the desired distance and angle. The fixture for the optical lens system holds different optical lens components, which may include one or more of: a double-convex optical lens, a narrow band optical filter, a neutral density filter, an optical protection filter, and a pinhole.

As shown in FIG. 6, an enclosure covers/retains the above-referenced components. In some embodiments the sensor is configured with a cooling system (e.g. liquid (like water) and/or gaseous). In some embodiments, the cooling system is integrated into the enclosure to cool the camera electronics during the AM building process because of the high-temperature environment.

In some embodiments, the sensor is configured with a gas-purge system (e.g. nitrogen) integrated into the enclosure and configured to allow pressurized gas to escape through the optical pinhole, thus reducing, preventing, and/or eliminating material deposition process vapors from contaminating or damaging the optical lens components. In some embodiments, the pinhole size is selected to allow adequate gas flow to protect the optics, while not allowing too much gas to enter the chamber and compromising the quality of the vacuum. In some embodiments, the pinhole is configured to enable the optical system to gather and image the light source (light from the impinging laser or electron gun) without undue interference.

### Example: Evaluation of a Lab-Scale z-Height Sensor

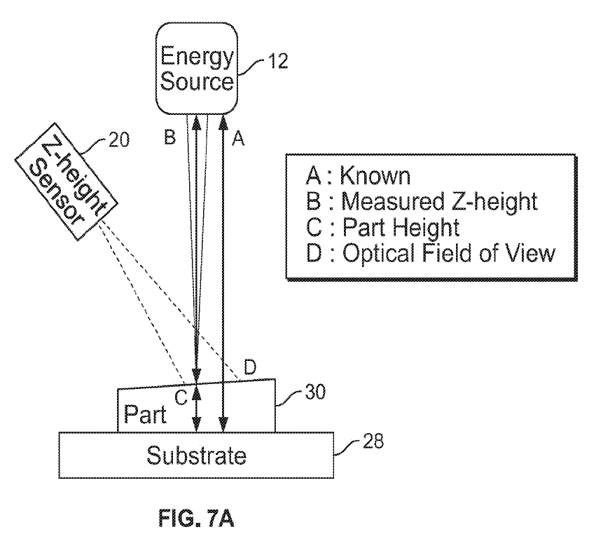

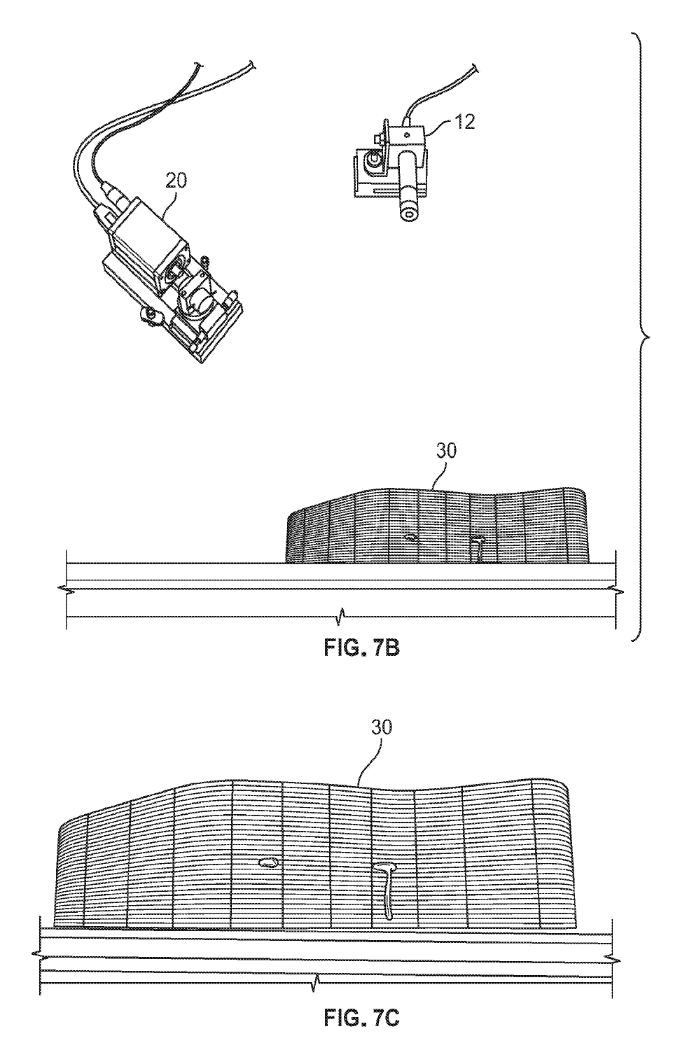

A lab-scale z-height sensor was configured based on the systems and methods detailed herein and evaluated with the setup shown in FIGS. 7A-7C. The calculated z-height and part height were measured on the AM part 30 across 10 locations from left to right on a representative cold AM part build (e.g. no active AM/no material deposition was in progress). As depicted in FIGS. 7B and 7C, the AM part build that was evaluated did have a dimensioned surface such that z-height would be varied if AM deposition was occurring. A laser point generator was utilized to replace the energy source.

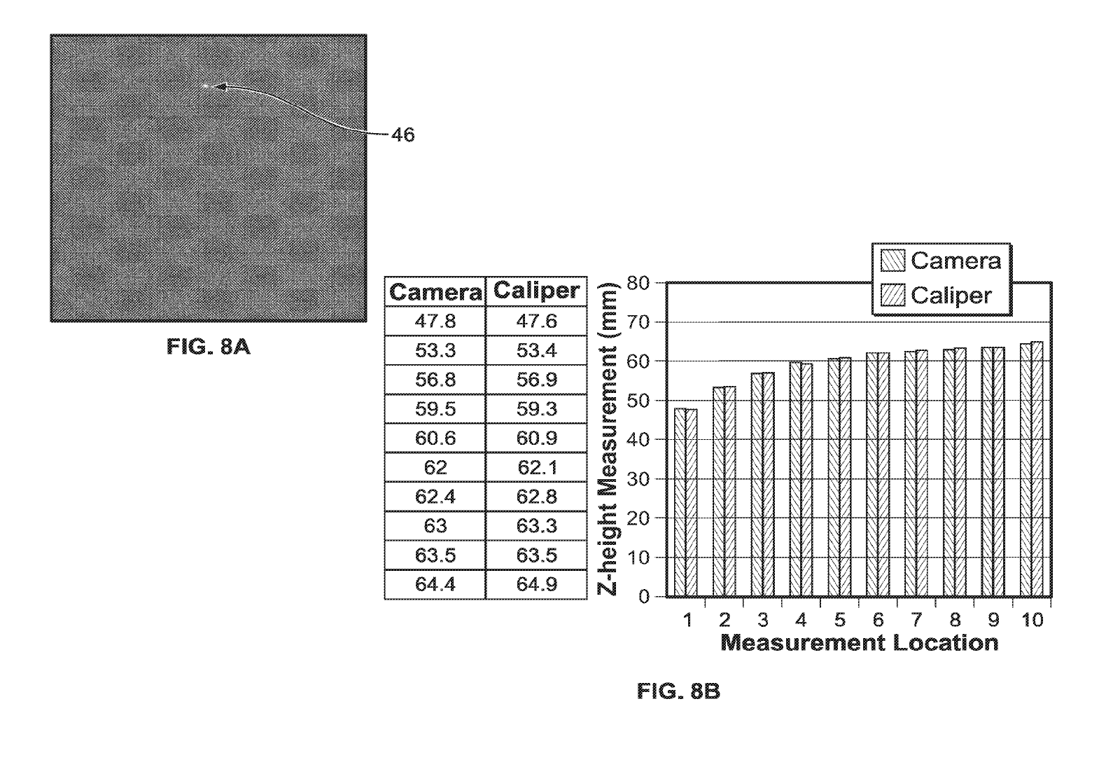

The image of the laser spot 46 on the part surface is shown in FIG. 8A, depicted as a binary image (image converted to black and white on a pixel-by-pixel basis). The measurement of the part height across 10 different locations is depicted in FIG. 8B, indicating that the z-height measurements obtained via the embodiment of the image sensor (camera) compared very well to those obtained through the control, a conventional measurement technique, calipers. The measurement accuracy is 0.5 mm or better, which, without being bound by any mechanism or theory, is believed to be sufficient for AM-based deposition applications.

### Example: Calculating Target z-Height

In some embodiments, a powder-bed based system is utilized, so a 3D CAD model of the AM part is generated, computationally sliced into 2D contours per layer, at which point the target height can be calculated for each build layer.

As the additive build incorporates layer upon layer to form the AM part, using a standard value for the deposition layer height, the build height of an individual AM layer or bead can be calculated. It is noted that variations in the additive manufacturing operation (e.g. time the energy source interacts with the feed material) can impact the temperature and thus, the width and depth (e.g. maybe more than one AM build layer of penetration) of the molten metal pool.

### Example: Identifying the Molten Pool

The x-coordinate of the molten metal pool is configured to the relative position between an energy source (e.g. E-beam gun) and the part (i.e. the x-coordinate of the metal pool will be straight down from the position of the E-beam).

In this embodiment, the sensor/imaging device (e.g. camera) is attached to the E-beam gun of a wire-feed based AM machine, such that the imaging device is in a fixed position relative to the E-beam gun and both move simultaneously during AM. The E-beam position is determined via its position from the E-beam gun, such that the center of the electron beam is assumed to be the center of the molten pool from the x axis.

### Example: Identifying y-Coordinate of the Molten Pool (yD)

In order to determine the y-coordinate for the center of mass of the molten pool, the y-coordinate for the center of a circle fitted in the molten pool is calculated, based on the radius of the circle and position relative to the x-coordinate.

The greyscale original image obtained from the imaging device/sensor is converted into a binary image. A global threshold is applied to all images, such that the global threshold renders pixels ranging from 0-255 into 0 if below the threshold and into 1 if above the global threshold. It is noted, the molten pool (white) and surrounding background (black) are visible/distinguishable with stark contrast.

In order to obtain the height or y-coordinate of the molten pool, circles are fit into the particles in the binary image such that the edges of the particles in the binary image bound the fit-circles. There may be a few to several to many particles in the binary image. It is possible to down-select into a single candidate particle that corresponds to the molten pool by calculating the area of each particle in the binary image (e.g. and remove those that are too small to be the size of the wire feed mixed together with molten pool).

There may be a few to several to many circles fit in the candidate particle, which are then compared and rejected based on the circle position being located outside of a zone of interest (e.g. relative to the x axis and x coordinates (corresponding to the position of the E-beam)). For example if the x-coordinate of the center of mass for a candidate circle is outside a region (i.e. relative to the electron beam and direction of AM build), then the entire circle can be removed as a candidate.

Once the best candidates are identified for the center of the molten pool, further down selection may be also completed by using the diameter of the fit-circle. The candidate fit-circle with the largest diameter should be the best candidate. The remaining circle will be the molten pool image, and the y-coordinate of the center of mass of the fit-circle is a variable needed to triangulate the z-height measurement.

Many times, the interaction between the feed material and the energy source (e.g. E-beam or laser) casts a shadow from the feed material onto the molten pool so the image of the leading edge of the molten pool is not a shape that a circle can easily fit in, in which case the y-coordinate of the molten pool is unable to be determined. In this case, there are a few steps to decide the y-coordinate:

1. Resample the binary image so only selected columns of pixels in the binary image will be analyzed next. The starting index of the selected column of pixels will be (x− radius) and the ending index of the selected column of pixels will be (x+ radius). X is the x-coordinate identified in the above example (e.g. para. [0075]-[0076] and the Radius is the identified above Radius (diameter divided by 2) (e.g. as in para. [0063].

2. In the resampled binary image, identify the y-coordinate (yB) of the bottom of the bounding rectangle of the particle that corresponds to the molten pool.

3. Calculate the y-coordinate of the molten pool image as (yB-radius). yB is identified in step 2, and radius (diameter divided by 2) (e.g. identified in para. [0083].

4. The calculated y-coordinate is a variable needed to triangulate the z-height measurement.

### Example: Evaluation of z-Height Sensor with In Situ AM

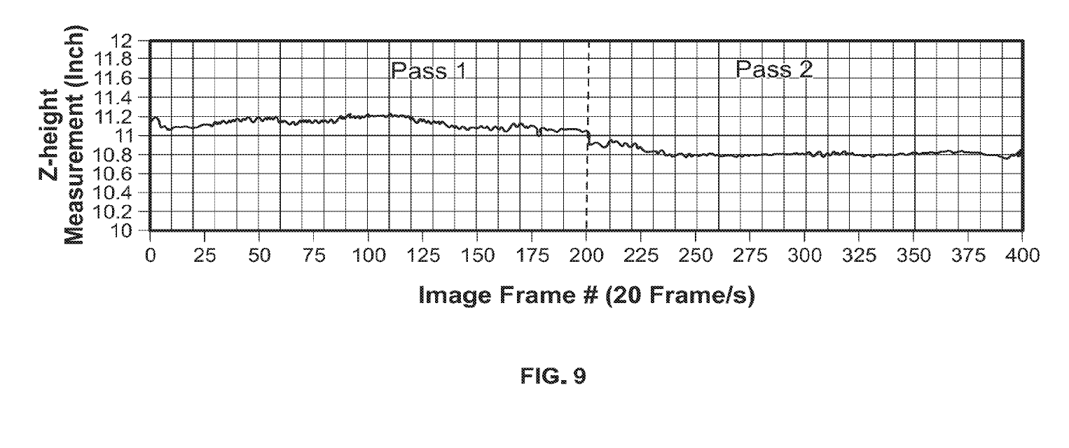

An on-line trial run was performed to test an embodiment of the in-situ z-height measurement sensor during the additive manufacturing process. The z height sensor was mounted onto the Sciaky system. Accordingly, images of the molten pool were continuously captured at a frame rate of 20 f/s by the z-height sensor. The images were processed in real time with an embodiment of the present method (e.g. employing the outlined approach and corresponding algorithms) for the z-height measurement in two different passes of the building process of a rectangular block part. FIG. 9 depicts the continuous z-height measurement results of the two different passes (AM bead deposition) for the in situ sensor that was tested. FIG. 9 provides experimental data for all images for both passes (i.e. frame #1-frame 400).

The z-height measurement results from image frame #1 to #200 (Pass 1) indicate there is a relatively high z-height for one pass, where the distance from the extracted molten pool is far away from the reference point on the E-beam gun. In this instance, the feed wire was melted at an undesirable high elevation and dripped onto the surface of the molten pool. Without being bound by a particular mechanism or theory, this is believed to result in an unstable build process and/or poor build quality of the resulting AM part (i.e. inconsistent microstructure and/or characteristics).

In contrast, the measurement results from image frame #201 to #400 (Pass 2) indicate an acceptable z-height, where the feed wire was melted right at the surface of the molten pool. Without being bound by a particular mechanism and/or theory, it is believed that the process (i.e. with an acceptable z-height) was more stable, and thus the build quality in the AM part is expected to be better (i.e. more consistent microstructure and/or characteristics).

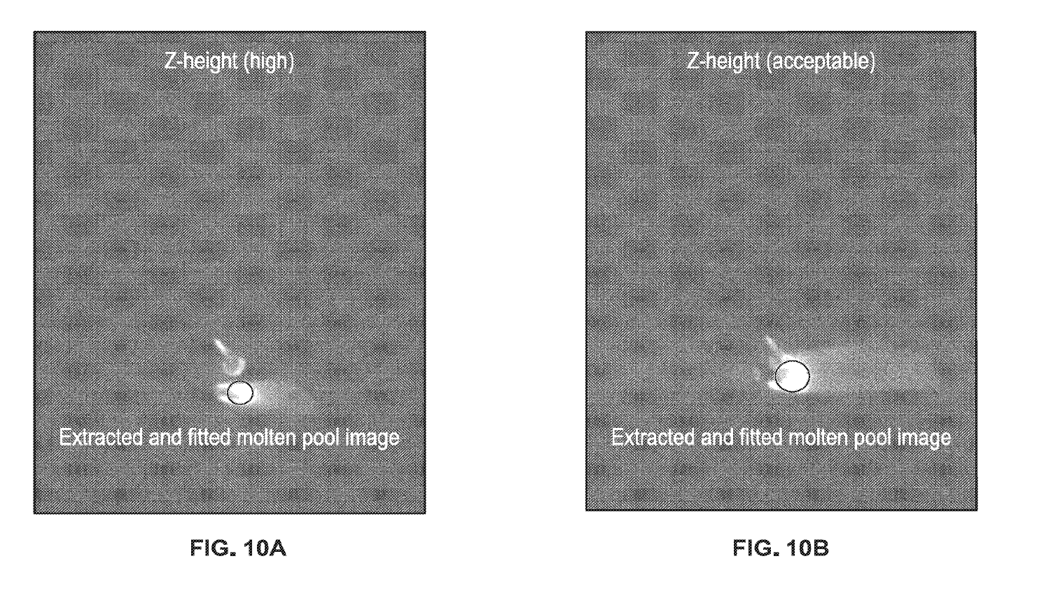

FIG. 10A and 10B depict different z-height images and processing results of the in situ sensor testing. Example images from Pass 1 (10A) and Pass 2 (10B) are shown side by side, with the resulting molten pool determination depicted by a hashed circle in the corresponding image. FIG. 10A shows the determined molten pool for a z-height that is too high, while FIG. 10B in contrast shows the determined molten pool for a z-height that is at an acceptable height (i.e. not too high or too low).

### REFERENCE NUMBERS

AM Machine 10

Energy source (electron beam) 12

Fixture 14

Controller 16

E-beam 18

Z-height sensor 20

Optics within sensor 22

Z-height 24

Feed material (wire feed—Sciaky, or powder delivery nozzle—Optomec) 26

Substrate 28

AM part being built (Prior deposits) 30

AM part (final) 32

Molten alloy puddle 34

Re-solidified alloy (in single deposition path) 36

Intersection Point E-beam and feed material 38

Feed Device 40

Motion motor (move/adjust energy source and z-height sensor) 42

z-height measurement module 44

Laser spot 46

What is claimed is:

1. A method, comprising:
additively manufacturing a part via a material deposition-based additive manufacturing technique;
concomitant with additively manufacturing the part, measuring a measured z-height of the material deposition-based additive manufacturing technique via a non-linear mathematical model to determine the measured z-height, wherein the measured z-height is a distance between an additive manufacturing system energy source and a top surface of a molten pool;
comparing the measured z-height with a target z-height to identify a difference between the measured z-height and the target z-height;
adjusting a motion controller to set a corrected z-height; and
depositing an additive manufacturing feed material based on the corrected z-height.

2. The method of claim 1, wherein the adjusting a motion controller comprises sending a signal to the motion controller coupled to the additive manufacturing system energy source to set the corrected z-height.

3. The method of claim 1, wherein the non-linear mathematical model is:
$${Z}^{+} = SD + \frac{h sin β ( {L}_{1} - f )}{f sin α - h cos α sin β}$$
$${Z}^{-} = SD - \frac{h sin β ( {L}_{1} - f )}{f sin α + h cos α sin β}$$
wherein SD is the stand-off distance between the additive manufacturing system energy source and (i) the molten pool (ii) or a surface of a deposited material in a previous layer;
wherein h is a distance between an image point a and an image point b on a physical image sensor unit;
wherein L1 is a distance from a lens center to the molten pool or to the surface of the deposited material in the previous layer;
wherein α is an angle between a line Aa and a direction of energy;
wherein β is an angle between the line Aa and an image sensor surface; and
wherein f is a focal length.

4. The method of claim 3, wherein the measured z-height is a negative value.

5. The method of claim 4, wherein the additive manufacturing system energy source is adjusted downward in a vertical direction toward the molten pool.

6. The method of claim 3, wherein the measured z-height is a positive value.

7. The method of claim 6, wherein the additive manufacturing system energy source is adjusted upward in a vertical direction away from the molten pool.

8. The method of claim 1, wherein the material deposition-based additive manufacturing technique is a wire-fed deposition technique.

9. The method of claim 1, wherein the material deposition-based additive manufacturing technique is an injectable fluidized powder-based deposition technique.

10. The method of claim 1, wherein the measured z-height is the target z-height.

11. The method of claim 1, wherein the measuring the z-height comprises:
taking an image of the molten pool via an imaging device;
correlating and calculating the position of the molten pool relative to the additive manufacturing system energy source via a designed non-linear mathematical model;
comparing the measured z height to the target z height;
calculating a deviation between the measured z-height and the target z-height; and
adjusting, via the motion controller, the height of the energy source relative to the top surface of the molten pool to minimize the deviation, if any, between the measured z-height and the target z-height.

12. The method of claim 11, wherein the imaging device is configured to measure a distance between a lowermost portion of the energy source to the top surface of the molten pool.

13. The method of claim 11, wherein parameters of the material deposition-based additive manufacturing technique are controlled in order to adjust the z-height.

14. The method of claim 13, wherein the z-height is adjusted based at least in part on adjusting a value of an E-beam power parameter.

15. The method of claim 13, wherein the z-height is adjusted based at least in part on adjusting a feed rate of the additive manufacturing feed material.

16. The method of claim 1, wherein the measured z-height is compared with the target z-height concomitantly with the additively manufacturing the part.

17. The method of claim 1, wherein the motion controller is adjusted to provide a corrected z-height to reduce the difference between the target z-height and the corrected z-height, concomitantly with the additively manufacturing the part.

18. An apparatus comprising:
a substrate having a first surface configured to hold an additively manufactured part;
an energy source disposed opposite the substrate and configured to direct an energy beam toward the first surface of the substrate;
a fixture having a first end and a second end, wherein the first end is coupled to a housing of the energy source;
a sensor coupled to a second end of the fixture, wherein the sensor is configured to image light in particular wavelengths emitted by hot additive manufacturing material; and
a motion controller coupled to the energy source and configured to adjust a vertical distance from the energy source to a top surface of additively manufactured part.

19. The apparatus of claim 18, wherein the motion controller comprises a motion motor and a controller.
